(19) United States
(12) Patent Application Publication
(10) Pub. No.: US 2009/0257569 A1
(43) Pub. Date: Oct. 15, 2009

(54) METHOD AND SYSTEM FOR PROVIDING GOODS OR SERVICES TO A SUBSCRIBER OF A COMMUNICATIONS NETWORK

(76) Inventors: Andrew N. BRISTOW, Toorak (AU); Robert I. WOOD, Montrose (AU)

Correspondence Address: MORGAN LEWIS & BOCKIUS LLP, 1111 PENNSYLVANIA AVENUE NW, WASHINGTON, DC, 20004, US

(21) Appl. No.: 12/490,045

(22) Filed: Jun. 23, 2009

Related U.S. Application Data
(63) Continuation of application No. 10/509,015, filed on Feb. 22, 2005, now abandoned.

(30) Foreign Application Priority Data
Mar. 27, 2003 (AU) PS 1424

(51) Int. Cl. H04M 11/00; G06Q 30/00; G06Q 50/00

(52) U.S. Cl. 379/93.02; 705/26

(57) ABSTRACT

A method for providing goods or services to a subscriber of a communications network, the method including the steps of: (a) verifying (40) a calling party number; (b) verifying (42) the identity of the subscriber associated with the calling party number; (c) verifying (44) the age of the subscriber; and, (d) providing (46) the subscriber with a subscriber identifier (PIN) to enable access to the goods or services. The invention is suitable for use in the provision of restricted communications

The present invention relates to the provision of goods or services to a subscriber of a communications network. The present invention has particular application in providing access to adult or like restricted telephone services, and it will be convenient to describe the invention in relation to these exemplary applications. It is to be realized, however, that the invention may be used in other applications in which goods or services may be selectively accessed or purchased by a subscriber to a communications network, such as a voice, data or other network, including fixed telephone networks, 3rd generation or mobile telephony networks or the Internet.

Telephony and Internet services providing content of an adult nature are now widely available. Upon the establishment of a connection with such a service, a subscriber is able to interact with a live operator or alternatively obtain pre-recorded adult content or connect to pre-recorded material. Because of the nature of the content thus provided, it is important that content be provided only to recognized subscribers having an age above that for which the receipt of such adult content is illegal or unauthorized. It is also important to accurately identify the calling party in order that the correct subscriber may be billed for the provision of the adult content.

Access to adult telephony services is currently available to a user upon entry of the details of a credit card. The adult content is then delivered, and the credit card holder billed for the provision of the services. Unfortunately, it is relatively easy for such credit card details to be illegally obtained, or for members of the credit card holder's family to obtain and use the credit card details for the unauthorized provision of the adult services.

It would therefore be desirable to provide a method and system for providing goods or services to a subscriber of a communications network in a manner that more accurately identifies an authorized subscriber than is presently the case.

It would also be desirable to provide a method and system for providing goods or services to a subscriber of a communications service that provides an improved level of security over existing methods and systems.

It would also be desirable to provide a method and system for providing goods or services to a subscriber of a communications service that ameliorates or overcomes one or more disadvantages of known methods and systems.

With this in mind, one aspect of the present invention provides a method for providing goods and services to a subscriber of a communications network, the method including the steps of:

(a) verifying a calling party number;

(b) verifying the identity of the subscriber associated with the calling party number;

(c) verifying the age of the subscriber; and,

(d) providing the subscriber with a subscriber identifier to enable access to the goods or services.

The subscriber identifier in step (d) may typically be a Personal Identification Number or PIN.

Step (a) may include:

receiving a manually generated number from the calling party; receiving an automatically transmitted calling party number; and

matching the manually generated number and the automatically transmitted calling party number.

Step (b) may include:

receiving manually generated data from the calling party,

accessing subscriber identity data from a subscriber database of calling party numbers and associated subscriber entities,

matching the subscriber identity data with the manually generated data.

The database may be a telephone directory, and may be accessible either locally or remotely.

Step (c) may include:

receiving manually generated age verification data from the calling part;

accessing subscriber age verification data from a database; and,

matching the subscriber age verification data with the manually generated age verification data.

The subscriber age verification data stored in the database may include credit card details and/or drivers' license numbers or other details.

The goods or services may be provided via a fixed or mobile telephony network, the Internet, or other communications network.

The goods or services may be a restricted communications service.

Another aspect of the present invention provides a system for providing goods or services to a subscriber of a communications network according to the above-described method.

For assistance in arriving at an understanding of the invention, one example of the method and system for providing goods or services to a subscriber of a communications network is illustrated in the accompanying drawings. However, it should be understood that the following description is illustrative only and should not be taken in any way as a restriction on the generality of the invention as described above.

### IN THE DRAWINGS

FIG. 1 is a schematic diagram showing one embodiment of a system for providing goods or services to a subscriber of a communications network; and

FIG. 2 is a flow chart illustrating the functional steps performed by the system of FIG. 1.

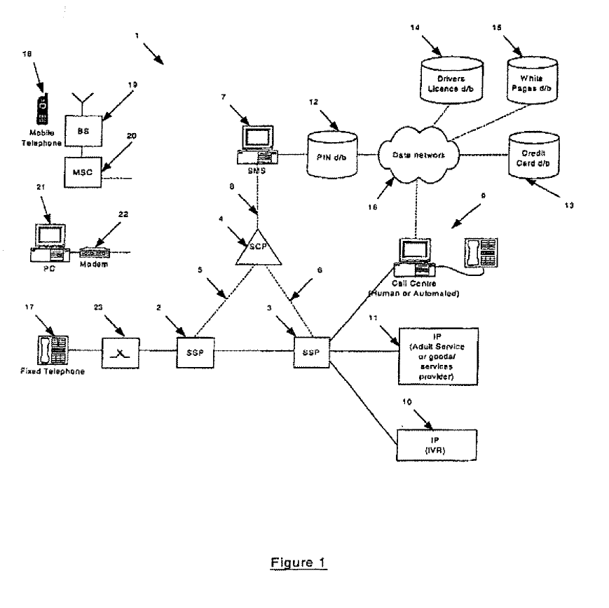

Referring now to FIG. 1, there is shown generally one example of a system for providing goods or services to a subscriber of a communications network, namely a system for providing restricted communications service to a subscriber. The system 1 uses an intelligent network for the provision of such services. The intelligent network consists of a number of switching entities that combine to offer subscribers specialized telephony services, such as services providing adult content. The switching entities contain processing software to process calls according to the required service. The intelligent network contains a number of Service Switching Points (SSP) 2, 3 each connected to a public telecommunications network such as a Public Switched Telephone Network (PSTN), an Integrated Services Digital Network (ISDN), a Packet Switched Public Data Network (PSPDN) or a mobile cellular network.

Each of the SSPs 2, 3 are linked to a Service Control Point (SCP) 4 via telecommunications data links 5, 6. The SCP 4 contains service specific application software and accesses customer or subscriber records. Each SSP 2, 3 reacts to specific service triggers and initiates queries to the SCP 4 over a common channel signaling link, such as the Signaling System No 7 (SS7) network, here illustrated by links 5, 6. The SCP 4 acts upon the query from the SSPs 2, 3 and returns a message containing the data and instructions required to complete the service. A Service Management System (SMS) 7 is linked to the SCP 4 by an SS7 link 8, and supports the administration of the customer records within the SCP 4.

The system 1 also includes a manual or automated call centre 9, an intelligent peripheral 10 providing an Interactive Voice Response (IVR) function, and an intelligent peripheral 11 for providing adult content to a subscriber. The system 1 also includes a database of personal identification numbers 12, a credit card database 13, a driver's license database 14 and a telephone directory database 15. Each of the databases 12 to 15 is accessible by the call centre 9 via a data network 16, such as the Internet. In addition, the personal identification number or PIN database 12 is accessible from the SMS 7.

It will be appreciated by a skilled addressee that some or all of the above-described network elements include a processing unit and associated memory device for storing a computer program element that causes the network element to operate as described below.

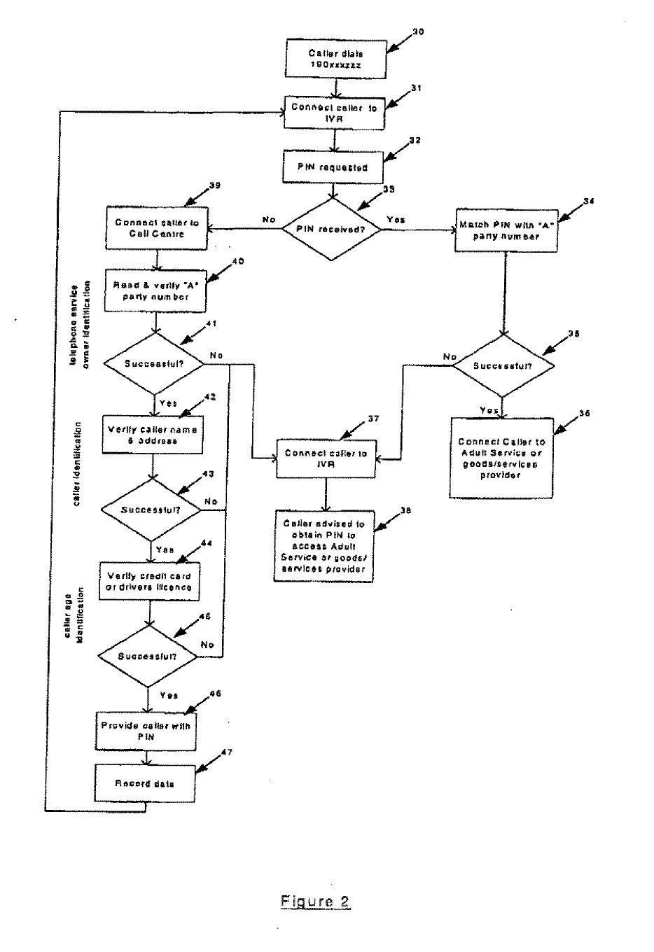

The operation of the system 1 will now be described with reference to FIG. 2. At step 30, a calling party wishing to receive content from the intelligent peripheral 11 may dial a predefined adult telephone service number, for example in the format 190 xxx zzz, from a fixed telephone handset 17. Alternatively, the calling party may dial the predefined adult telephone service number from a mobile telephony device 18 in radio communication with a base station 19 and mobile switching centre 20.

In a further variant, the predefined adult telephone service number may be dialed from a personal computer 21 or other subscriber terminal. In a first example, the personal computer 21 may be connected to a network conforming to the IP protocol and assigned a static IP address for use in the present invention as a “calling party number”.

In a second example, the personal computer 21 is connectable to a variety of communications networks, such as the PSTN and ISDN fixed telephony networks, and the Internet, via a modem 22. Typically, the calling party wishing to access adult content provided from a selected web site will established a connection to the Internet by using the modem 22 to connect the personal computer 21 to an Internet Service Provider (ISP). Upon navigation to the selected web site, an Internet dialer program will be served from the web site to the personal computer 21. The calling party is then requested to access restricted or adult content provided by that web site by activating the adult dialer program, whereupon the Internet dialer program causes the modem to disconnect the personal computer 21 from the ISP and re-dial the above-mentioned predefined adult telephone service number. A connection is established with the web site, in order that the calling party is served with adult or other restricted content, by the entity associated with the adult telephone service number. The calling party is billed at an elevated rate, such as an ISDN call rate, rather than the lower cost call rate offered by the ISP.

The call initiated by the calling party is routed via one or more switching exchanges 23 to one of the SSPs 2, 3. At step 31 having previously received instructions from the SCP 4 dictating how calls made with a calling party or “A” number of 190 xxx zzz, are to be handled, the call is routed to the intelligent peripheral 10 for further processing. From establishment of a connection with the intelligent peripheral 10, a pre-recorded announcement is issued to the caller at step 32 requesting that the calling party provide, either verbally or by means of a telephone or numeric keypad, a personal identification number or PIN.

In alterative embodiments, the functionality of the intelligent peripheral 10 may be provided by a web site. In such cases, the pre-recorded announcement need not be provided to the calling party as audio content, but may also be presented as text or other content.

If the intelligent peripheral 10 determines, at step 32, that a PIN has been entered, that PIN is transmitted by the intelligent peripheral 10, together with the automatically transmitted calling party or “A” number, to the SCP 4 for forwarding to the SMS 7. Upon receipt of the “A” party number and the manually generated PIN, the SMS 7 consults the PIN database 12 to determine whether the PIN entered corresponds to a PIN previously issued to the subscriber associated with detected calling party number (step 34). If a match between the automatically transmitted “A” party number and the manually entered PIN is determined, at step 35, to be successful, the call is routed from the SSP 3 to the intelligent peripheral 11 at step 36, for provision of the restricted communications service to the calling party.

In alternative embodiments, the intelligent peripheral 11 may be replaced by a web site. The content provided to the calling party in such cases need not be limited to audio content only, but may include video and text content.

If the manually entered PIN does not correspond with the detected “A” party number at step 35, the calling party 17 is connected at step 37 to the intelligent peripheral 10 once more. At step 38, the intelligent peripheral 10 plays a pre-recorded voice announcement or alternative format message to the calling party advising the calling party that access to the adult service can only be obtained by firstly obtaining a PIN.

If at step 33 no PIN is determined to have been received, the call from the calling party 17 is routed to the call centre 9, at step 39. A process to match a calling party with a subscriber service is then undertaken at the call centre 9, at step 40. Although in this embodiment the call centre is operable with, and forms part of, a fixed telephony network, it is to be understood that various other network elements may be used to provide the functionality of the call centre. For example, a web site may provide the call party with a series of text-based prompts and fields for data entry in response to the prompts to replicate the functionality of the call centre. Various other alternative network elements will be able to be envisaged by skilled addressees in this field.

The calling party is initially requested by the call centre 9 to manually generate, either verbally or by use of the telephone or numeric keypad or keyboard, the calling party or “A” number from which access to the adult service is requested. The automatically transmitted calling party number is also read at the call centre 9, and compared to the manually generated calling party number provided by the calling party.

If it is determined at step 41 that this matching was successful, a process of verifying the identity of the subscriber (as opposed to the calling party) is then undertaken. Accordingly, at step 42, the calling party is requested to provide details of their name and address or other caller identification details. Those name and address details are then compared against details recorded for subscribers in the telephone directory database 15 that is accessed from the call centre 9 via the data network 16. It will be appreciated that in alternative embodiments, the telephone directory database 15 may be stored on a local storage medium, such as a CD-ROM

If it is determined at step 43 that the caller identification process has been successful, the calling party is then required at step 44 to manually generate, by verbal indication, by use of a telephone or numeric keypad, either credit card details or drivers license details. Depending upon the type of information received at the call centre 9, either the driver's license database 14 or the credit card database 13 is then accessed. In each of these databases, records are created that enable the matching of a numerical or other field (such as a driver's license number or credit card number) with name and address detail. Moreover, the existence of a record on each of the databases indicates that the driver's license holder or credit card holder is at or above the age required to legally receive adult services.

The credit card or drivers license details provided at step 44 are accordingly combined with the caller name and address details provided in step 42 and attempted to be matched in one or both of the driver's license database 14 or credit card database 13. If this process of establishing the caller's age is successful at step 45, the call centre 9 accesses the PIN database 12 via the data network 16 and selects an unused PIN for use by the calling party. The call centre 9 provides this PIN to the subscriber or calling party at step 46. Details of the subscriber that are captured at steps 40, 42, 44 and 46 are then transmitted via the SSP 2, 3 to the SCP 4 for recordal by the SMS 7 in the PIN database 12, at step 47.

Having now been provided with a PIN, a subscriber is able, at a future time, to once again dial the requisite 190 xxx zzz number to establish a connection with intelligent peripheral 10 at step 31. Alternatively should the subscriber wish to immediately access the restricted communications service the subscriber will be connected to the intelligent peripheral 10 at step 31 and requested to enter the newly required PIN.

If any of the data collection and verification steps result in an unsuccessful process at steps 41, 43 or 45, the calling party is connected to the intelligent peripheral 10 at step 37 and, at step 38, advised that access to the adult service provided by the intelligent peripheral 11 may be had only by manually entering an appropriate PIN.

Those skilled in the art will appreciate that there may be many variations and modifications of the previously described system and method for providing goods or services to a subscriber of a communications network as described herein which are within the scope of the present invention. Notably, it will be understood that goods or services may be accessed according to the present invention not only from within a fixed telephone network environment, but also from within 3rd generation and other mobile telephony networks, an Internet environment, an Short Messaging Service (SMS), email or other messaging environment, a Wireless Application Protocol (WAP) environment, or other suitable communications platforms.

The present invention may, for example, be used in applications in which the subscriber is able to access or purchase goods or services via a fixed telephone, the Internet or m-commerce application. Moreover, the goods or services are not limited to restricted communications services only, but may be of a more general nature.

The functionality of the various network elements described here above may be provided by intelligent peripherals, manual or automated call centers, web sites or other suitable manual or automatic network elements facilitating user interaction, depending upon the type of communications network connected to that network element.

1. A method for providing goods or services to a subscriber of a communications network, the method including the steps of: (a) verifying a calling party number; (b) verifying the identity of the subscriber associated with the calling party number; (c) verifying the age of the subscriber; and, (d) providing the subscriber with a subscriber identifier to enable access to the goods or services.

2. A method according to claim 1, wherein the subscriber identifier in step (d) is a Personal Identification Number or PIN.

3. A method according to claim 1, wherein step (a) includes: receiving a manually generated number from the calling party; receiving an automatically transmitted calling party number; and, matching the manually generated number and the automatically transmitted calling party number.

4. A method according to claim 1, wherein step (b) includes: receiving manually generated data from the calling party; accessing subscriber identity data from a subscriber database of calling party numbers and associated subscriber entities; and, matching the subscriber identity data with the manually generated data.

5. A method according to claim 4, wherein the database is a telephone directory.

6. A method according to claim 5, wherein the database is accessible locally or remotely.

7. A method according to claim 1, wherein step (c) includes: receiving manually generated age verification data from the calling party; accessing subscriber age verification data from a database; and, matching the subscriber age verification data with the manually generated age verification data.

8. A method according to claim 7, wherein the subscriber age verification data stored in the database includes credit card details and/or drivers license numbers.

9. A method according to claim 1, wherein the goods or services are accessed or provided via a fixed or mobile telephony network.

10. A method according to claim 1, wherein the goods or services are accessed or provided via the Internet.

11. A method according to claim 1, wherein the goods or services are a restricted communications service.

12. A system for providing goods or services to a subscriber of a communications network, the system including: number verification means for verifying a calling party number; identity verifying means for verifying the identity of the subscriber associated with the calling party umber; age verifying means verifying the age of the subscriber; and, subscriber identifier notification means for providing the subscriber with a subscriber identifier to enable access to the goods or services.

13. A system according to claim 12, wherein the subscriber identifier is a Personal Identification Number or PIN.

14. A method according to claim 12, wherein the number verification means acts to receive a manually generated number from the calling party; receive an automatically transmitted calling party number; and, match the manually generated number and the automatically transmitted calling party number.

15. A system according to claim 12, wherein the identity verifying means acts to: receive manually generated data from the calling party; access subscriber identity data from a subscriber database of calling party numbers and associated subscriber entities; and, match the subscriber identity data with the manually generated data.

16. A system according to claim 15, wherein the database is a telephone directory.

17. A system according to claim 16, wherein the database is accessible locally or remotely.

18. A system according to claim 12, wherein the age verifying means acts to: receive manually generated age verification data from the calling party; access subscriber age verification data from a database; and, match the subscriber age verification data with the manually generated age verification data.

19. A system according to claim 18, wherein the subscriber age verification data stored in the database includes credit card details and/or drivers license numbers.

20. A system according to claim 12, wherein the goods or services are accessed or provided via a fixed or mobile telephony network.

21. (canceled)
